(19) United States
(12) Patent Application Publication
(10) Pub. No.: US 2024/0163697 A1
(43) Pub. Date: May 16, 2024

(54) Management for Background Data Transfer (BDT)

(71) Applicant: Telefonaktiebolaget LM Ericsson (publ), Stockholm (SE)

(72) Inventors: Wenliang Xu, Shanghai (CN); Fuencisla Garcia Azorero, Madrid (ES); Susana Fernandez Alonso, Madrid (ES)

(21) Appl. No.: 18/281,900

(22) PCT Filed: Mar. 15, 2021
(86) PCT No.: PCT/CN2021/080779

§ 371 Date: Sep. 13, 2023

(51) Int. Cl. H04W 24/04; H04L 41/0654

(52) U.S. Cl. CPC H04W 24/04; H04L 41/0654

(57) ABSTRACT

The present disclosure proposes methods and network elements for managing background data transfer (BDT). A method for managing BDT comprises: receiving, from a second network element, a first request for subscription of notification for network performance recovery; determining that network performance is recovered from a degraded network performance; and transmitting, to the second network element, a first notification for network performance recovery.

### TECHNICAL FIELD

The present disclosure is related to the field of telecommunication, and in particular, to management for background data transfer (BDT).

### BACKGROUND

Currently, many Communication Service Providers (CSPs) exploit different charging strategies for its users or subscribers depending on different time periods and/or locations where the UEs are located, in order to balance loads in their networks to increase the return on investment (ROI). To maximize the usage of non-busy hours or locations, they don't mind offering lower tariff during the non-busy hours or at the non-busy locations to their users or subscribers. For example, CSPs may employ a lower charging rate at night than that during daytime. For another example, CSPs may employ a lower charging rate in a cell where traffic is relatively low than a cell where traffic is relatively heavy.

On the other hand, users or subscribers, who have a large number of non-time-critical data needed to be transferred, may be eager to transfer the data in a time period or location with a lower charging rate, to reduce cost of the data traffic. For example, in an Internet of Things (IoT), which is a network of physical objects, such as vehicles, machines, home appliances, that use sensors and Application Programming Interfaces (APIs) to connect and exchange data over the Internet, there is a large number of non-time-critical data (such as firmware update, logging data) needed to be transferred between IoT devices and their associated application server. IoT device owners or operators may be eager to keep the data traffic cost lower and they don't mind shifting such data traffic to non-busy hours or locations.

To address the needs from both sides, a mechanism called “Background Data Transfer (BDT)” is proposed, which supports a background data transfer policy to be applied either to an existing session via N5 or a future session when UE establishes a Protocol Data Unit (PDU) session. With BDT, a user or subscriber can initiate a transfer for non-time-critical data in a specific time window with a lower charging rate and optionally a specific geographical area with a lower charging rate.

### SUMMARY

According to a first aspect of the present disclosure, a method at a first network element for managing background data transfer (BDT) is provided. The method comprises: receiving, from a second network element, a first request for subscription of notification for network performance recovery; determining that network performance is recovered from a degraded network performance; and transmitting, to the second network element, a first notification for network performance recovery.

In some embodiments, before the step of determining that network performance is recovered from a degraded network performance, the method further comprises: transmitting, to a third network element, a second request for subscription of notification for network performance recovery; and receiving, from the third network element, a second notification for network performance recovery. In some embodiments, the step of determining that network performance is recovered from a degraded network performance comprises: determining that the network performance is recovered from a degraded network performance at least partially based on the received second notification.

In some embodiments, each of the first and second requests for subscription of notification for network performance recovery also requests for subscription of notification for network performance degradation. In some embodiments, the method further comprises: determining that network performance is degraded; and transmitting, to the second network element, a third notification for network performance degradation.

In some embodiments, before the step of determining that network performance is degraded, the method further comprises: receiving, from the third network element, a fourth notification for network performance degradation. In some embodiments, the step of determining that network performance is degraded comprises: determining that the network performance is degraded at least partially based on the received fourth notification.

In some embodiments, each of the first and second requests further indicates a desired time window for BDT.

In some embodiments, after the step of receiving, from a second network element, a first request for subscription of notification for network performance recovery, the method further comprises: determining one or more first candidate BDT policies at least partially based on network performance for the desired time window; and transmitting, to the second network element, the determined one or more first candidate BDT policies.

In some embodiments, the method further comprises: receiving, from the second network element, a message indicating a BDT policy selected from the one or more first candidate BDT policies; and transmitting, to a fourth network element, a request for storing the selected BDT policy as a degraded and currently selected BDT policy or a desired and currently selected BDT policy depending on whether the network performance is degraded or not.

In some embodiments, the method further comprises: receiving, from the second network element, a message indicating that none of the one or more first candidate BDT policies is selected.

In some embodiments, upon the step of determining that the network performance is degraded, the method further comprises: determining one or more second candidate BDT policies at least partially based on degraded network performance. In some embodiments, the step of transmitting, to the second network element, a third notification for network performance degradation comprises: transmitting, to the second network element, the determined one or more second candidate BDT policies together with the third notification.

In some embodiments, the method further comprises: receiving, from the second network element, a message indicating a BDT policy selected from the one or more second candidate BDT policies; and transmitting, to the fourth network element, a request for storing the selected BDT policy as a degraded and currently selected BDT policy.

In some embodiments, the method further comprises: determining whether a time window of the selected BDT policy is identical to that of any of currently subscribed notifications for network performance or not; and transmitting, to the third network element, a request for subscription of notification for network performance for the time window of the selected BDT policy, in response to determining that the time window of the selected BDT policy is not identical to that of any of currently subscribed notifications for network performance.

In some embodiments, the method further comprises: transmitting, to the third network element, a request for un-subscription of notification for network performance for a time window of a previously selected BDT policy, if any, when the previously selected BDT policy is a degraded BDT policy.

In some embodiments, the method further comprises: receiving, from the second network element, a message indicating that none of the one or more second candidate BDT policies is selected; and transmitting, to the fourth network element, a request for removing the previously selected BDT policy if any.

In some embodiments, the method further comprises: transmitting, to the fourth network element, a request for removing the previously selected BDT policy, if any, in response to receiving no response from the second network element within a period of time since the determined one or more second candidate BDT policies are transmitted to the second network element.

In some embodiments, upon the step of determining that the network performance is recovered, the method further comprises: determining one or more third candidate BDT policies at least partially based on recovered network performance. In some embodiments, the step of transmitting, to the second network element, a first notification for network performance recovery comprises: transmitting, to the second network element, the determined one or more third candidate BDT policies and/or the degraded and currently selected BDT policy, if any, together with the first notification.

In some embodiments, the method further comprises: receiving, from the second network element, a message indicating a BDT policy newly selected from the one or more third candidate BDT policies and/or the degraded and currently selected BDT policy; and transmitting, to a fourth network element, a request for storing the newly selected BDT policy as the desired and currently selected BDT policy.

In some embodiments, the method further comprises: determining whether a time window of the newly selected BDT policy is identical to that of any of currently subscribed notifications for network performance or not; and transmitting, to the third network element, a request for subscription of notification for network performance for the time window of the newly selected BDT policy, in response to determining that the time window of the newly selected BDT policy is not identical to that of any of currently subscribed notifications for network performance.

In some embodiments, the method further comprises: transmitting, to the third network element, a request for un-subscription of notification for network performance for the previously desired time window when the previously desired time window is different from the time window of the newly selected BDT policy.

In some embodiments, the method further comprises: transmitting, to the third network element, a request for un-subscription of notification for network performance for the time window of the previously selected BDT policy, if any, when the time window of the previously selected BDT policy is different from the time window of the newly selected BDT policy.

In some embodiments, the first network element is a Policy Control Function (PCF), the second network element is a Network Exposure Function (NEF), the third network element is a Network Data Analytics Function (NWDAF), and the fourth network element is a Unified Data Repository (UDR).

According to a second aspect of the present disclosure, a first network element is provided. The first network element comprises: a processor; and a memory storing instructions which, when executed by the processor, cause the processor to perform the any method of the first aspect.

According to a third aspect of the present disclosure, a method at a second network element for managing background data transfer (BDT) is provided. The method comprises: receiving, from a fifth network element, a fifth request for subscription of notification for network performance recovery; transmitting, to a first network element, a first request for subscription of notification for network performance recovery at least partially based on the fifth request; receiving, from the first network element, a first notification for network performance recovery; and transmitting, to the fifth network element, a fifth notification for network performance recovery at least partially based on the received first notification.

In some embodiments, each of the first and fifth requests for subscription of notification for network performance recovery also requests for subscription of notification for network performance degradation. In some embodiments, the method further comprises: receiving, from the first network element, a third notification for network performance degradation; and transmitting, to the fifth network element, a sixth notification for network performance degradation at least partially based on the received third notification.

In some embodiments, each of the first and fifth requests further indicates a desired time window for BDT.

In some embodiments, after the step of transmitting, to a first network element, a first request for subscription of notification for network performance recovery, the method further comprises: receiving, from the first network element, one or more first candidate BDT policies; and transmitting, to the fifth network element, the received one or more first candidate BDT policies.

In some embodiments, the method further comprises: receiving, from the fifth network element, a message indicating a BDT policy selected from the one or more first candidate BDT policies; and transmitting, to the first network element, a message indicating the selected BDT policy.

In some embodiments, the method further comprises: receiving, from the fifth network element, a message indicating none of the one or more first candidate BDT policies is selected; and transmitting, to the first network element, a message indicating that none of the one or more first candidate BDT policies is selected.

In some embodiments, the step of receiving, from the first network element, a third notification for network performance degradation comprises: receiving, from the first network element, one or more second candidate BDT policies together with the third notification. In some embodiments, the step of transmitting, to the fifth network element, a sixth notification for network performance degradation comprises: transmitting, to the fifth network element, the one or more second candidate BDT policies together with the sixth notification.

In some embodiments, the method further comprises: receiving, from the fifth network element, a message indicating a BDT policy selected from the one or more second candidate BDT policies; and transmitting, to the first network element, a message indicating the selected BDT policy.

In some embodiments, the method further comprises: receiving, from the fifth network element, a message indicating that none of the one or more second candidate BDT policies is selected; and transmitting, to the first network element, a message indicating that none of the one or more second candidate BDT policies is selected.

In some embodiments, the step of receiving, from the first network element, a first notification for network performance recovery comprises: receiving, from the first network element, one or more third candidate BDT policies and/or a degraded and currently selected BDT policy, if any, together with the first notification. In some embodiments, the step of transmitting, to the fifth network element, a fifth notification for network performance recovery comprises: transmitting, to the fifth network element, the one or more third candidate BDT policies and/or the degraded and currently selected BDT policy, if any, together with the fifth notification.

In some embodiments, the method further comprises: receiving, from the fifth network element, a message indicating a BDT policy newly selected from the one or more third candidate BDT policies and/or the degraded and currently selected BDT policy; and transmitting, to the first network element, a message indicating the newly selected BDT policy.

In some embodiments, the first network element is a Policy Control Function (PCF), the second network element is a Network Exposure Function (NEF), and the fifth network element is an Application Function (AF).

According to a fourth aspect of the present disclosure, a second network element is provided. The second network element comprises: a processor; and a memory storing instructions which, when executed by the processor, cause the processor to perform the any method of the third aspect.

According to a fifth aspect of the present disclosure, a method at a fifth network element for managing background data transfer (BDT) is provided. The method comprises: transmitting, to a second network element, a fifth request for subscription of notification for network performance recovery; and receiving, from the second network element, a fifth notification for network performance recovery.

In some embodiments, the fifth request for subscription of notification for network performance recovery also requests for subscription of notification for network performance degradation. In some embodiments, the method further comprises: receiving, from the second network element, a sixth notification for network performance degradation.

In some embodiments, the fifth request further indicates a desired time window for BDT.

In some embodiments, after the step of transmitting, to a second network element, a fifth request for subscription of notification for network performance recovery, the method further comprises: receiving, from the second network element, one or more first candidate BDT policies; selecting a BDT policy from the received one or more first candidate BDT policies; and transmitting, to the second network element, the selected BDT policy as the desired and currently selected BDT policy.

In some embodiments, after the step of transmitting, to a second network element, a fifth request for subscription of notification for network performance recovery, the method further comprises: receiving, from the second network element, one or more first candidate BDT policies; selecting none of the one or more first candidate BDT policies; and transmitting, to the second network element, a message indicating none of the one or more first candidate BDT policies is selected.

In some embodiments, the step of receiving, from the second network element, a sixth notification for network performance degradation comprises: receiving, from the second network element, one or more second candidate BDT policies together with the sixth notification.

In some embodiments, the method further comprises: selecting a BDT policy from the one or more second candidate BDT policies; and transmitting, to the second network element, a message indicating the selected BDT policy as the degraded and currently selected BDT policy.

In some embodiments, the method further comprises: selecting none of the one or more second candidate BDT policies; and transmitting, to the second network element, a message indicating that none of the one or more second candidate BDT policies is selected.

In some embodiments, the step of receiving, from the second network element, a fifth notification for network performance recovery comprises: receiving, from the second network element, one or more third candidate BDT policies and/or the degraded and currently selected BDT policy, if any, together with the fifth notification.

In some embodiments, the method further comprises: selecting a BDT policy from the one or more third candidate BDT policies and/or the currently selected BDT policy; and transmitting, to the second network element, a message indicating the newly selected BDT policy.

In some embodiments, the second network element is a Network Exposure Function (NEF), and the fifth network element is an Application Function (AF).

According to a sixth aspect of the present disclosure, a fifth network element is provided. The fifth network element comprises: a processor; and a memory storing instructions which, when executed by the processor, cause the processor to perform the any method of the fifth aspect.

According to a seventh aspect of the present disclosure, a computer program comprising instructions is provided. The instructions, when executed by at least one processor, cause the at least one processor to carry out the method of any method of the first aspect, the third aspect and the fifth aspect.

According to an eighth aspect of the present disclosure, a carrier is provided. The carrier contains the computer program of the fourth aspect, wherein the carrier is one of an electronic signal, optical signal, radio signal, or computer readable storage medium.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary message flow between various nodes in an exemplary telecommunication network for negotiating a BDT policy, according to an embodiment of the present disclosure;

FIG. 2 is a diagram illustrating an exemplary message flow between various nodes in an exemplary telecommunication network for BDT warning notification, according to an embodiment of the present disclosure;

FIG. 3 is a diagram illustrating an exemplary message flow between various nodes in an exemplary telecommunication network for negotiating a BDT policy according to another embodiment of the present application;

FIG. 4 is a diagram illustrating an exemplary message flow between various nodes in an exemplary telecommunication network for BDT warning notification, according to another embodiment of the present disclosure;

FIG. 5 is a diagram illustrating an exemplary message flow between various nodes in an exemplary telecommunication network for BDT recovery notification, according to another embodiment of the present disclosure;

FIG. 6 is a diagram illustrating an exemplary state machine for BDT policy negotiation in PCF, according to an embodiment of the present disclosure;

FIG. 7 is a diagram illustrating an exemplary state machine for BDT policy negotiation in AF, according to an embodiment of the present disclosure;

FIG. 8 is a flow chart of an exemplary method at a first network element for managing BDT according to an embodiment of the present disclosure;

FIG. 9 is a flow chart of an exemplary method at a second network element for managing BDT according to an embodiment of the present disclosure;

FIG. 10 is a flow chart of an exemplary method at a fifth network element for managing BDT according to an embodiment of the present disclosure;

FIG. 11 is a block diagram of an exemplary first network element according to an embodiment of the present disclosure;

FIG. 12 is a block diagram of an exemplary second network element according to an embodiment of the present disclosure;

FIG. 13 is a block diagram of an exemplary fifth network element according to an embodiment of the present disclosure; and

FIG. 14 schematically shows an embodiment of an arrangement which may be used in a first network element, a second network element and/or a fifth network element according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5th Generation New Radio (5G NR), the present disclosure is not limited thereto. In fact, as long as BDT management is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, or any other equivalents. Further, the term “node” used herein may refer to a UE, a functional entity, a network entity, a network element, a network equipment, or any other equivalents.

Further, the following 3GPP document is incorporated herein by reference in their entireties:
3GPP TS 23.502 V16.4.0 (2020-03), 3rd Generation Partnership Project; Technical Specification Group Services and System Aspects; Procedures for the 5G System (5GS); Stage 2 (Release 16).

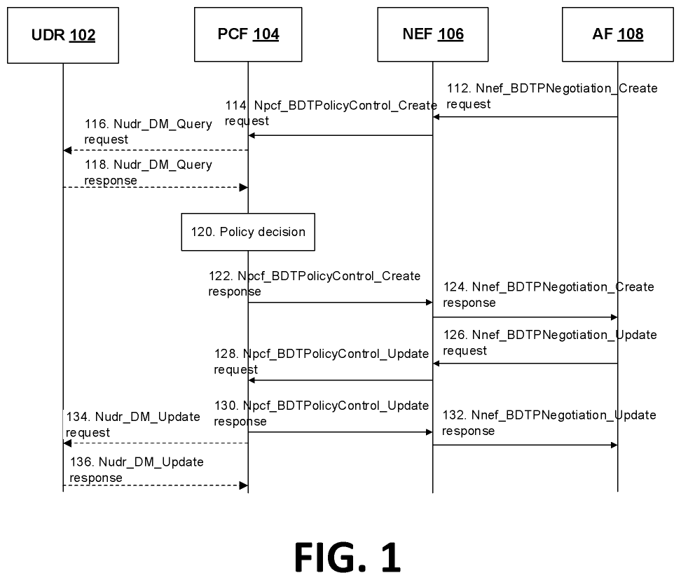

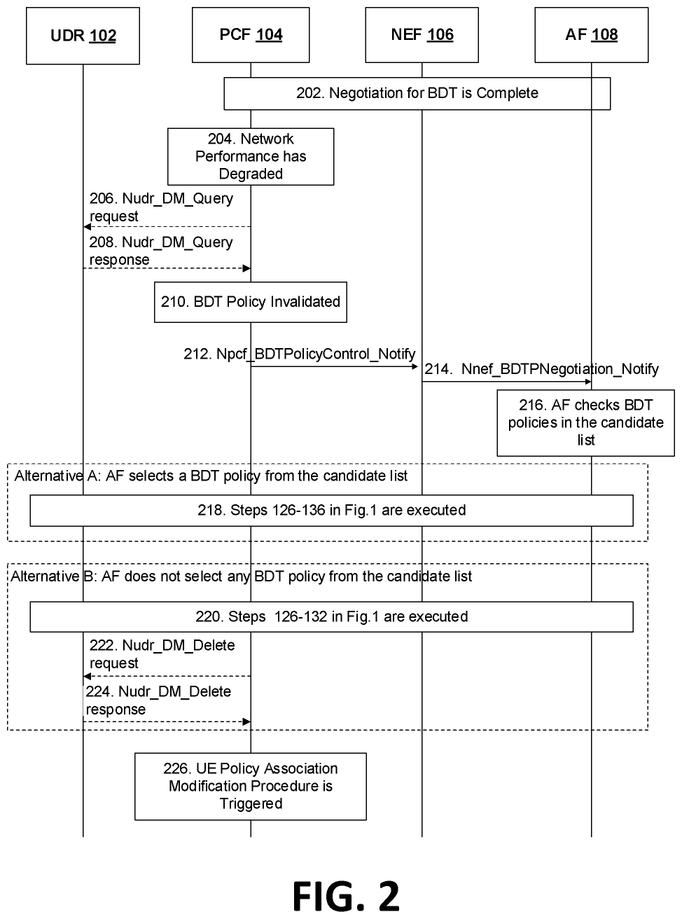

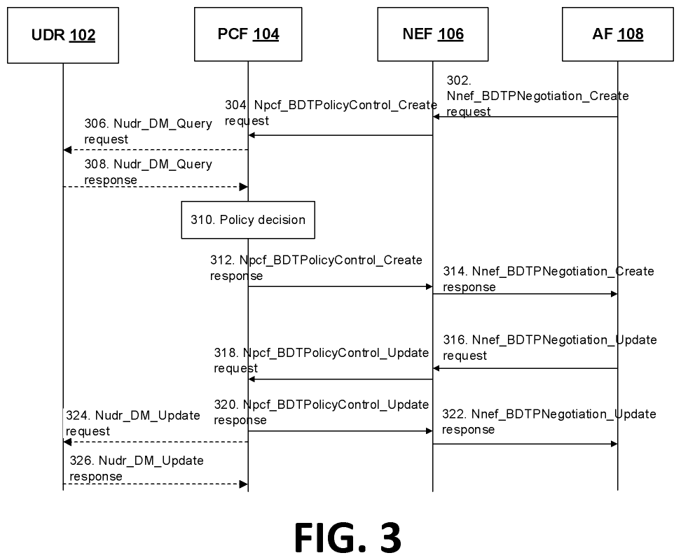

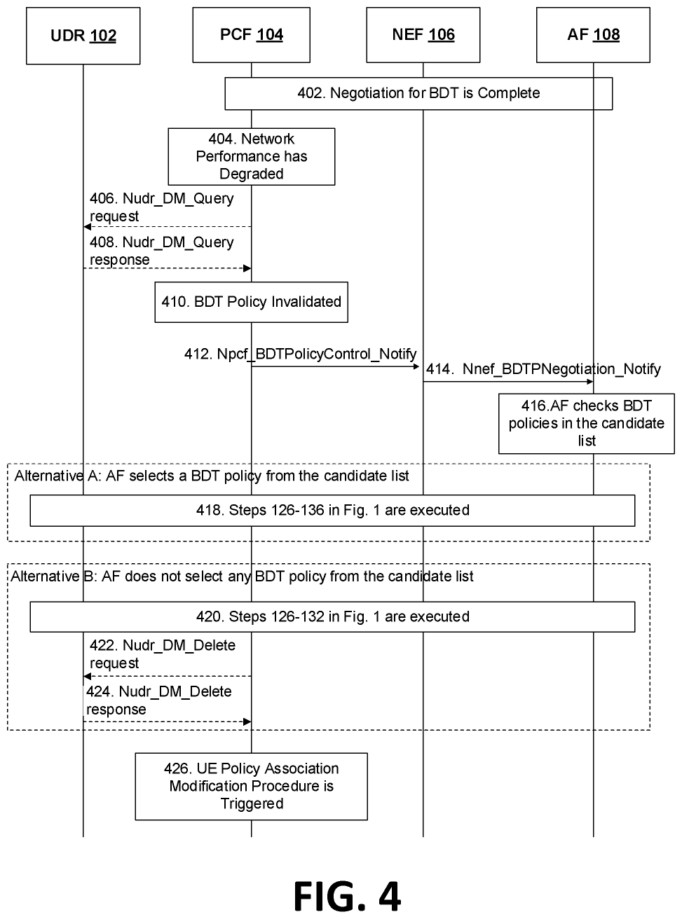

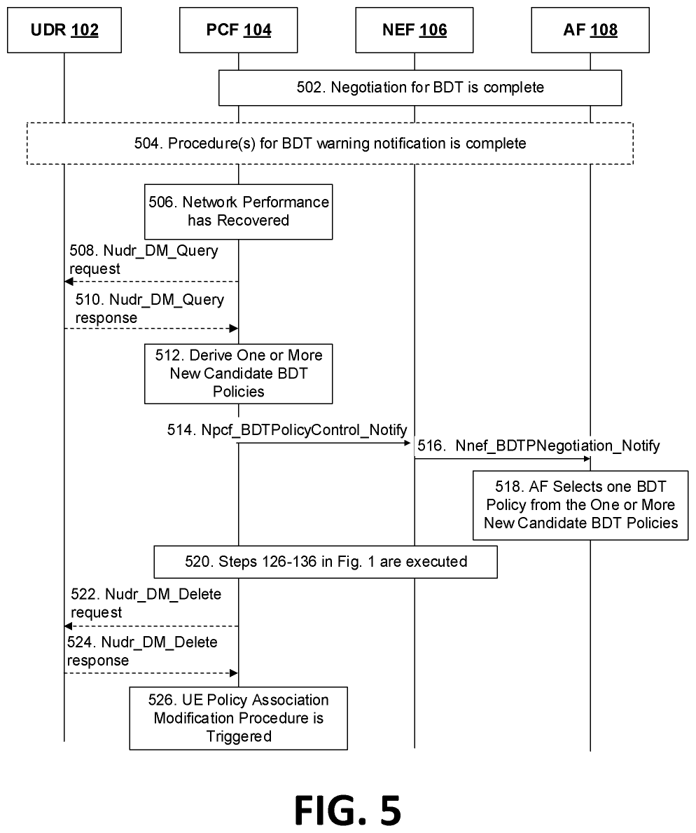

FIG. 1 is a diagram illustrating an exemplary message flow between various nodes in an exemplary telecommunication network for negotiating a BDT policy according to an embodiment of the present disclosure. In FIG. 1, the telecommunication network may be a 5G NR network which may comprise a Unified Data Repository (UDR) 102, a Policy Control Function (PCF) 104, a Network Exposure Function (NEF) 106, and an Application Function (AF) 108. However, these nodes are given only for the purpose of illustration, and the present disclosure is not limited thereto. In some other embodiments, more nodes, less nodes, and/or different nodes may be involved in a similar procedure for negotiating a BDT policy. For example, in some case, the information required for negotiating a BDT policy may be stored locally in the PCF 104 and thus the UDR 102 may be omitted.

As shown in FIG. 1 the procedure for negotiating a BDT policy is started at step 112, where the AF 108 may transmit, to the NEF 106, an Nnef_BDTPNegotiation_Create request message as described in 3GPP TS 23.502, clause 4.16.7.2, to negotiate a BDT policy on behalf of a group of UEs. It should be understood that the Nnef_BDTPNegotiation_Create request is only provided as an example. More generally, the AF 108 may transmit, to the NEF 106, any BDT request message for negotiating a BDT policy.

The Nnef_BDTPNegotiation_Create request message may comprise some parameters, such as Application Service Provider (ASP) identifier, volume of data to be transferred per UE, expected amount of UEs, desired time window, External Group Identifier. The “volume per UE” parameter describes the volume of data the AF 108 expects to be transferred per UE. The “number of UEs” parameter describes the expected amount of UEs participating in the BDT. The “desired time window” (e.g. 2020-10-01 to 2020-10-05) parameter describes the time interval during which the AF 108 wants to realize the data transfer. Optionally, the AF 108 can further provide Network Area Information, Non-IP information or IP 3-tuple to identify application server, and a request for notification. The AF 108 can provide either a geographical area (e.g. a civic address or shape), or an area of interest that includes a list of Tracking Areas (TAs) or list of NG-RAN (Next Generation Radio Access Network) nodes and/or a list of cell identifiers as Network Area Information. The request for notification is an indication that a BDT warning notification should be sent to the AF 108. The BDT warning notification indicates to the ASP that the BDT policy needs to be re-negotiated because network conditions under which BDT policy was selected have deteriorated/degraded.

At step 114, the NEF 106 may transmit, to the PCF 104, an Npcf_BDTPolicyControl_Create request message as described in 3GPP TS 23.502, clause 4.16.7.2, to negotiate a BDT policy. It should be understood that the Npcf_BDTPolicyControl_Create request is only provided as an example. More generally, the NEF 106 may transmit, to the PCF 104, any BDT request message for negotiating a BDT policy.

Before transmitting the Npcf_BDTPolicyControl_Create request message, the NEF 106 may also map some of the parameters included in the Nnef_BDTPNegotiation_Create message into parameters that are suitable for PCF 104. For example, when the AF 108 provides a geographical area as Network Area Information, the NEF 106 may map the geographical area based on local configuration into of a short list of TAs and/or NG-RAN nodes and/or cells identifiers. The NEF 106 may further map the ASP identifier provided by the AF 108 based on local configuration into the Data Network Name (DNN), Single Network Slice Selection Assistance Information (S-NSSAI).

At step 116, upon reception of Npcf_BDTPolicyControl_Create request message, the PCF 104 may transmit, to the UDR 102, an Nudr_DM_Query request message as described in 3GPP TS 23.502, clause 4.16.7.2, for requesting all existing BDT policies. It should be understood that, the Nudr_DM_Query request is only provided as an example. More generally, the PCF 104 may transmit, to the UDR 102, any BDT policy request message for requesting all existing BDT policies.

At step 118, the UDR 102 may transmit, to the PCF 104, an Nudr_DM_Query response message as described in 3GPP TS 23.502, clause 4.16.7.2. The Nudr_DM_Query response message may comprise all existing BDT policies stored in the UDR 102. It should be understood that, the Nudr_DM_Query response is only provided as an example. More generally, the UDR may transmit, to the PCF 104, any BDT policy response message for indicating all the existing BDT policies.

In an embodiment, for example, where there is only one PCF 104 in the telecommunication network, all the existing BDT policies can be locally stored in the PCF 104 and no interaction with UDR 102 is required. Thus, steps 116 and 118 can be omitted.

At step 120, the PCF 104 may perform a BDT decision. To be specific, the PCF 104 may determine one or more candidate BDT policies from all existing BDT policies received in step 118, for example, based on information comprised in the Npcf_BDTPolicyControl_Create request message received from the NEF 106 at step 114, and other available information. In an embodiment, to be able to adapt BDT policy/policies delivered to the AF 108/NEF 106 to network conditions, the PCF 104 may retrieve analytics on “Network Performance” from a Network Data Analytics Function (NWDAF) (not shown in FIG. 1) in an area where UEs of this ASP are expected to be located during a certain time period. The analytics on “Network Performance” may include the tuple-(expected load in the area of interest, expected number of UEs of this ASP in the Area of Interest) following the procedure and services described in TS 23.288. Afterwards, the PCF 104 may determine, based on the information comprised in the Npcf_BDTPolicyControl_Create request message, the analytics on “Network Performance” provided by the NWDAF and other available information (e.g. network policy and existing background transfer policies), one or more candidate BDT policies.

In an embodiment, a BDT policy may comprise a time window for BDT, a reference to charging rate for this time window. Optionally, the BDT policy may further comprise a maximum aggregated bitrate (indicating that charging according to the referenced charging rate is only applicable for aggregated traffic of all involved UEs that stays below this value).

At step 122, the PCF 104 may transmit, to the NEF 106, an Npcf_BDTPolicyControl_Create response message as described in 3GPP TS 23.502, clause 4.16.7.2. The Npcf_BDTPolicyControl_Create response message may comprise at least the determined one or more candidate BDT policies. In an embodiment, the Npcf_BDTPolicyControl_Create response message may further comprise a BDT reference ID. It should be understood that Npcf_BDTPolicyControl_Create response is only provided as an example. More generally, the PCF 104 may transmit, to the NEF 106, any BDT response message for providing the determined one or more candidate BDT policies and optionally the BDT reference ID.

At step 124, the NEF 106 transmits, to the AF 108, an Nnef_BDTPNegotiation_Create response message as described in 3GPP TS 23.502, clause 4.16.7.2, which may comprise the determined one or more candidate BDT policies and optionally the BDT reference ID. The Nnef_BDTPNegotiation_Create response is only provided as an example. More generally, the NEF 106 may transmit, to the AF 108, any BDT response message for providing the determined one or more candidate BDT policies and optionally the BDT reference ID.

Upon receipt of the Nnef_BDTPNegotiation_Create response message, the AF 108 may select one BDT policy from the one or more candidate BDT policies. In another embodiment, the AF 108 does not select any BDT policy from the one or more candidate BDT policies. The selection may be based on several factors, such as one or more parameters included in each of the one or more candidate BDT policies, and/or one or more parameters included in the Nnef_BDTPNegotiation_Create request message.

At step 126, the AF 108 may transmit an Nnef_BDTPNegotiation_Update request message as described in 3GPP TS 23.502, clause 4.16.7.2 to the NEF 106, and NEF 106 may then transmit, to the PCF 104 at step 128, an Nnef_BDTPolicyControl_Update request message as described in 3GPP TS 23.502, clause 4.16.7.2, to indicate the selected BDT policy to the PCF 104. As acknowledgements, the PCF 104 may transmit, at step 130, an Npcf_BDTPolicyControl_Update response message as described in 3GPP TS 23.502, clause 4.16.7.2 to the NEF 106, which may then transmit, at step 132, an Nnef_BDTPNegotiation_Update response message as described in 3GPP TS 23.502, clause 4.16.7.2 to the AF 108. It should be understood that, all of the messages used in steps 126-132 are only provided as an example. More generally, any other messages for implementing the functions of steps 126-132 can be used.

Further, as mentioned above, the AF 108 may select no BDT policy from the one or more candidate BDT policies. In this case, the Nnef_BDTPNegotiation_Update request and Nnef_BDTPolicyControl_Update request messages may comprise information for indicating such “NONE SELECTED” status. In an alternative embodiment, if the AF 108 selects no BDT policy from the one or more candidate BDT policies, steps 126-132 may be omitted. The PCF 104 may understand that none of the one or more candidate policies is selected without receiving any message from the NEF 106 for indicating a selected BDT policy.

At step 134, the PCF 104 may transmit, to the UDR 102, an Nudr_DM_Update request message as described in 3GPP TS 23.502, clause 4.16.7.2 for storing information regarding the selection of BDT policy (e.g., the selected BDT policy or the “NONE SELECTED” status) by the AF 108 in the UDR 102.

Finally, at step 136, the UDR 102 may transmit, to the PCF 104, an Nudr_DM_Update response message as described in 3GPP TS 23.502, clause 4.16.7.2 as an acknowledgement. It should be understood that, both of Nudr_DM_Update request and Nudr_DM_Update response used in steps 134 and 136 are only provided as an example. More generally, any other message for implementing the functions of steps 134 and 136 can be used.

In order to improve BDT, a procedure for BDT warning notification can be implemented with an NWDAF. As mentioned above, the Nnef_BDTPNegotiation_Create request message may comprise a request for notification, which is an indication that a BDT warning notification should be sent to the AF 108. The BDT warning notification indicates to the ASP/AF 108 that the BDT policy needs to be re-negotiated because network conditions under which BDT policy was selected have deteriorated/degraded.

FIG. 2 is a diagram illustrating an exemplary message flow between various nodes in an exemplary telecommunication network for BDT warning notification, according to an embodiment of the present disclosure. In the embodiment shown in FIG. 2, the telecommunication network may be a 5G NR network which may comprise a UDR 102, a PCF 104, an NEF 106, and an AF 108. However, these nodes are given only for the purpose of illustration, and the present disclosure is not limited thereto. In some other embodiments, more nodes, less nodes, and/or different nodes may be involved in a similar procedure for negotiating a BDT policy. Further, please note that similar nodes in FIG. 1 and FIG. 2 are given similar reference numerals for ease of understanding.

As shown in FIG. 2, the procedure for BDT warning notification can be started at step 202 where the negotiation for BDT is complete. For example, procedure of the negotiation for BDT can be implemented as shown in FIG. 1.

At step 204, the PCF 104 may determine that network performance for the desired time window (indicated in the Nnef_BDTPNegotiation_Create request message) has degraded, by subscribing, to an NWDAF, notification of network performance degradation. For example, the PCF 104 may set a threshold value to the NWDAF and require the NWDAF to send back a notification of network performance degradation when the network performance monitored by the NWDAF falls below the threshold value.

At steps 206 and 208, the PCF 104 may obtain all existing BDT policies and information about the current selection of BDT policy by the AF 108 stored in the UDR 102. Steps 206 and 208 are similar to steps 116 and 118 in FIG. 1, respectively, and their detailed description is not repeated here. After receiving all the existing BDT policies, the PCF 104 may identifies BDT policies from all the existing BDT policies that are affected by the notification received from the NWDAF. The PCF 104 may then determine whether a new list of candidate BDT policies can be calculated. If so, the PCF 104 may determine a new list of candidate BDT policies. In an embodiment, the determined new list of candidate BDT policies may contain the BDT policy that is currently selected/used by the AF 108. If the PCF 104 does not find any new candidate BDT policy, the previously negotiated BDT policy shall be kept and no interaction with the AF 108 shall occur. That is, steps 210-226 are not performed.

At step 210, the PCF 104 may set the previously negotiated BDT policy in the UDR 102 as invalidated, when the PCF 104 determines that a new list of candidate BDT policies should be calculated.

At steps 212 and 214, the PCF 104 may transmit, to the AF 106, the new list of candidate BDT policies via the NEF 106, using Npcf_BDTPolicyControl_Notify and Nnef_BDTPolicyControl_Notify messages as described in 3GPP TS 23.502, clause 4.16.7.3. It should be understood that, the Npcf_BDTPolicyControl_Notify and Nnef_BDTPolicyControl_Notify are only provided as an example, and any other message for implementing the corresponding functions can be used.

At step 216, the AF 108 may check the BDT policies in the new list of candidate BDT policies.

In an embodiment, the AF 108 may select a BDT policy from the new list of candidate BDT policies (corresponding to “Alternative A” in FIG. 2). In this case, the procedure may proceed to step 218 where steps 126-136 in FIG. 1 are executed.

In another embodiment, the AF 108 does not select any BDT policy from the new list of candidate BDT policies (corresponding to “Alternative B” in FIG. 2). In this case, the procedure may proceed to step 220 where steps 126-132 in FIG. 1 are executed. Alternatively, when the AF 108 does not select any BDT policy, step 220 may be omitted, and the PCF 104 will understand that no BDT policy is selected without receiving any message for indicating the selected BDT policy. At steps 222 and 224, the PCF 104 may interact with the UDR 102 to require the UDR 102 to remove the stored negotiated BDT policy, if any, for example, using the Nudr_DM_Delete request and Nudr_DM_Delete response message as described in 3GPP TS 23.502, clause 4.16.7.3. It should be understood that, Nudr_DM_Delete request and Nudr_DM_Delete response are only provided as an example, and any other message for implementing the corresponding functions can be used.

Finally and optionally, at step 226, a UE Policy Association Modification procedure as defined in 3GPP TS 23.502, clause 4.16.12.2 may be triggered in the PCF 104, where if there is a new BDT policy stored in the UDR 102, the PCF 104 may be notified by the UDR 102.

Although BDT is improved with the procedure for BDT warning notification as shown in FIG. 2, there is currently no mechanism to notify the AF 108 about situation that network performance is recovered from previous degradation.

To be specific, the following problems may exist:
For BDT policy/policies provided to AF during initial BDT negotiation where network performance cannot satisfy the AF expectation (e.g. desired time window), if the AF selects an inferior BDT policy (which may be of low charging rate, delayed time window and/or lower maximum aggregated bandwidth for data transfer), the AF is unaware of the reason why it is selecting a more restrictive BDT policy. The AF cannot select a different BDT policy if network performance is recovered.
For BDT policy/policies provided to AF during BDT renegotiation due to warning notification, the AF selects an inferior BDT policy and cannot reselect a different one if network performance deterioration ceases.
Although AF can start a new BDT negotiation with 3GPP Core Network (CN) regardless intention of receiving BDT notification in the old BDT negotiation, a ready selected BDT policy in the old BDT negotiation cannot be un-selected or invalidated in the 3GPP CN which will affect the PCF decision to derive new BDT policy/policies since PCF needs to consider all existing valid BDT policies. Also this put high demand on the AF side to monitor the network performance, and a threshold set by AF is not consistent with that set by PCF (i.e. by Mobile Network Operator (MNO)) in NWDAF analytics.

In order to solve or mitigate the above problems, an improved solution may be proposed, which allows:
The AF is aware of the network performance for the requested conditions when receiving candidate BDT policies.
The AF/NET can subscribe with the PCF to notifications about:
   warning of network performance degradation; and
   recovery of network performance, cease of warning.

FIG. 3 is a diagram illustrating an exemplary message flow between various nodes in an exemplary telecommunication network for negotiating a BDT policy according to another embodiment of the present application. In the embodiment shown in FIG. 3, the telecommunication network may be a 5G NR network which may comprise a UDR 102, a PCF 104, an NEF 106, and an AF 108. However, these nodes are given only for the purpose of illustration, and the present disclosure is not limited thereto. In some other embodiments, more nodes, less nodes, and/or different nodes may be involved in a similar procedure for negotiating a BDT policy. For example, in some case, the information required for negotiating a BDT policy may be stored locally in the PCF 104 and thus the UDR 102 may be omitted. Further, please note that similar nodes in FIG. 1-FIG. 3 are given similar reference numerals for ease of understanding.

It should be understood that all of the messages used in FIG. 3 are illustrative and not-limiting. Any other messages that can implement the corresponding functions can be used without departing the spirit and scope of the present disclosure. Note that the procedure shown in FIG. 3 is similar to that shown in FIG. 1, and the following primarily focuses on steps in FIG. 3 that are different from those in FIG. 1.

As shown in FIG. 3, the procedure for negotiating a BDT policy is started at step 302, where the AF 108 may transmit, to the NEF 106, an Nnef_BDTPNegotiation_Create request message. In addition to the parameters described with respect to FIG. 1 and an indicator for requesting a notification of network performance degradation described with respect to FIG. 2, the Nnef_BDTPNegotiation_Create request message in FIG. 3 may further comprise an indicator for requesting a notification of network performance recovery, which notification may indicate that network performance is recovered from a degraded network performance. Further, in some other embodiments, this indicator may be comprised in the Nnef_BDTPNegotiation_Create request message without the request for notification of network performance degradation. In other words, the AF 108 may request a notification for network recovery only without a notification for network degradation.

At step 304, the NEF 106 may transfer, to the PCF 104, the request for notification of network performance recovery together with other information, for example, using an Npcf_BDTPolicyControl_Create request message.

Steps 306 and 308 are similar to steps 116 and 118 in FIG. 1, respectively, and their detailed descriptions are not repeated here.

At step 310, the PCF 104 may interact with an NWDAF to determine network performance for desired time window and/or location and/or network area which is indicated in the Nnef_BDTPNegotiation_Create request message, and determine one or more candidate BDT policies. In an embodiment, the PCF 104 may subscribe, to the NWDAF, a notification of network performance (including degradation and/or recovery) for desired time window and/or location and/or network area.

At step 312, the PCF 104 may indicate to the NEF 106 whether the one or more candidate BDT policies for desired time window and/or location and/or network area are determined considering a degraded network performance condition or a good/optimal network performance condition, together with the determined one or more candidate BDT policies, for example, using an Npcf_BDTPolicyControl_Create response message. In an embodiment, if the PCF 104 determines that the network performance for the desired time window and/or location and/or network area is degraded, it may include a notification of network performance degradation together with the determined one or more candidate BDT policies in the Npcf_BDTPolicyControl_Create response message. In another embodiment, if the PCF 104 determines that the network performance for the desired time window and/or location and/or network area is good/optimal, it may include an optimal notification together with the determined one or more candidate BDT policies in the Npcf_BDTPolicyControl_Create response message. In yet another embodiment, if the PCF 104 determines that the network performance for the desired time window and/or location and/or network area is good/optimal, it may not include any notification of network performance in the Npcf_BDTPolicyControl_Create response message. In this case, the AF 108 will understand that the one or more candidate BDT policies for desired time window and/or location and/or network area are determined considering a good/optimal network performance condition without receiving notification of network performance degradation.

At step 314, the NEF 106 may indicate, to the AF 108, the notification of network performance together with the determined one or more candidate BDT policies, for example, using an Nnef_BDTPNegotiation_Create response message.

Steps 316-322 are similar to steps 126-132 in FIG. 1, respectively, and their detailed descriptions are not repeated here.

At step 324, the PCF 104 may transmit, to the UDR 102, an Nudr_DM_Update request message, for storing the selection of BDT policy by the AF 108 in the UDR 102. Similar to FIG. 1, the AF 108 may or may not select a BDT policy under a degraded network performance, and accordingly, the PCF 104 may indicate to UDR 102 to store the selected BDT policy or the “NONE SELECTED” status.

In an embodiment, if the AF 108 selects a BDT policy under degraded network performance, the PCF 104 may further subscribe, to the NWDAF, notification of network performance for a time window and/or location of the selected BDT policy. In another embodiment, the PCF 108 may further mark the BDT policy selected under the degraded network performance as “degraded BDT policy” and store it into the UDR.

In an embodiment, the PCF 104 may mark a BDT policy selected under a good/optimal network performance as “desired BDT policy” and store it into the UDR 102. Alternatively, the BDT policy selected under the good/optimal network performance may not be marked. In this case, a BDT policy that is not marked as “degraded BDT policy” is considered a BDT policy in a good/optimal network performance condition.

Finally, at step 326, the UDR 102 may transmit, to the PCF 104, an Nudr_DM_Update response message as an acknowledgement.

FIG. 4 is a diagram illustrating an exemplary message flow between various nodes in an exemplary telecommunication network for BDT warning notification according to another embodiment of the present application. In the embodiment shown in FIG. 4, the telecommunication network may be a 5G NR network which may comprise a UDR 102, a PCF 104, an NEF 106, and an AF 108. However, these nodes are given only for the purpose of illustration, and the present disclosure is not limited thereto. In some other embodiments, more nodes, less nodes, and/or different nodes may be involved in a similar procedure for negotiating a BDT policy. Further, please note that similar nodes in FIG. 1-FIG. 4 are given similar reference numerals for ease of understanding.

It should be understood that all of the messages used in FIG. 4 are illustrative and not-limiting. Any other messages that can implement the corresponding functions can be used without departing the spirit and scope of the present disclosure. Note that the procedure shown in FIG. 4 is similar to that shown in FIG. 2, and the following primarily focuses on steps in FIG. 4 that are different from those in FIG. 2.

As shown in FIG. 4, the procedure for BDT warning notification can be started at step 402 where the negotiation for BDT is complete. For example, the negotiation for BDT can be implemented as shown in FIG. 2.

At step 404, the PCF 104 may determine that network performance for the desired time window has degraded by subscribing, to an NWDAF, notification of network performance degradation. For example, the PCF 104 may set a threshold value to the NWDAF and require the NWDAF to send back a notification of network performance degradation when the network performance monitored by the NWDAF falls below the threshold value.

Steps 406 and 408 are similar to steps 206 and 208 in FIG. 2, respectively, and their detailed description is not repeated here.

At step 410, the PCF 104 may set the previously negotiated BDT policy in the UDR 102 as invalidated, when the PCF 104 determines that a new list of candidate BDT policies should be calculated. In an embodiment, the PCF 104 may subscribe, to the NWDAF, notification of network performance for the desired time window (e.g. 2020-10-01 to 2020-10-05) and/or location and/or network area, if such subscription was not done before, for example, if the network performance for the procedure of BDT negotiation is good/optimal.

Steps 412-414 are similar to steps 212-214 in FIG. 2, and their detailed descriptions are not repeated here.

At step 416, the AF 108 may check the BDT policies in the new list of candidate BDT policies.

In one embodiment, the AF 108 may select a BDT policy from the new list of candidate BDT policies (corresponding to “Alternative A” in FIG. 4). In this case, the procedure may proceed to step 418 where steps 126-136 in FIG. 1 are executed. In an embodiment, if the previously negotiated BDT policy is a “degraded BDT policy” and the AF 108 selects at step 416 a new BDT policy that is different from the previously “degraded BDT policy”, the PCF 104 may remove the previously “degraded BDT policy” from the UDR 102, mark the newly selected BDT as a “degraded BDT policy”, and store it into the UDR 102. In this case, the PCF may further unsubscribe, to the NWDAF, the notification of network performance for the time window of the previously “degraded BDT policy”, and subscribe, to the NWDAF, notification of network performance for time window of the newly selected BDT policy.

In another embodiment, if no BDT policy is selected during the procedure of negotiation of BDT policy at step 402, the PCF 104 may mark the BDT policy selected by the AF at step 416 as a “degraded BDT policy”, and store it into the UDR 102. In this case, the PCF 104 may further subscribe, to the NWDAF, notification of network performance for time window of the selected BDT policy.

In yet another embodiment, if the previously negotiated BDT policy is selected under a good/optimal network performance and the AF 108 select, at step 416, a BDT policy that is different from the previously negotiated BDT policy, the PCF 104 may mark the selected BDT policy as a “degraded BDT policy”, and store it into the UDR 102. In this case, the PCF 104 may further subscribe, to the NWDAF, notification of network performance for time window of the previously negotiated BDT policy. In yet another embodiment, if the previously negotiated BDT policy is selected under a good/optimal network performance and the AF 108 select the previously negotiated BDT policy at step 416, the PCF 104 may store the selected BDT policy into the UDR 102, and keep the subscription of the notification of network performance for the desired time window/location and/or network area.

In another embodiment, the AF 108 may select no BDT policy from the new list of candidate BDT policies (corresponding to “Alternative B” in FIG. 4). In this case, the procedure may proceed to step 420 where steps 126-132 in FIG. 1 are executed. Alternatively, when the AF 108 does not select BDT policy at step 416, step 220 may be omitted, and the PCF 104 will understand that no BDT policy is selected without receiving any message for indicating the selected BDT policy.

At steps 422 and 424, the PCF 104 may interact with the UDR 102 to require the UDR 102 to remove the stored negotiated BDT policy (if any), for example, using an Nudr_DM_Delete request and Nudr_DM_Delete response message as described in 3GPP TS 23.502, clause 4.16.7.3. It should be understood that, the Nudr_DM_Delete request and Nudr_DM_Delete response are only provided as an example, and any other message for implementing the corresponding functions can be used.

Finally and optionally, at step 426, a UE Policy Association Modification procedure as defined in 3GPP TS 23.502, clause 4.16.12.2 may be triggered in the PCF 104, where if there is a new BDT policy stored in the UDR 102, the PCF 104 may be notified by the UDR 102.

FIG. 5 is a diagram illustrating an exemplary message flow between various nodes in an exemplary telecommunication network for BDT recovery notification, according to an embodiment of the present application. In the embodiment shown in FIG. 5, the telecommunication network may be a 5G NR network which may comprise a UDR 102, a PCF 104, an NEF 106, and an AF 108. However, these nodes are given only for the purpose of illustration, and the present disclosure is not limited thereto. In some other embodiments, more nodes, less nodes, and/or different nodes may be involved in a similar procedure for negotiating a BDT policy. Further, please note that similar nodes in FIG. 1-FIG. 5 are given similar reference numerals for ease of understanding.

The procedure as shown in FIG. 5 may be started at step 502, where the negotiation for BDT is complete. The procedure of negotiation for BDT can be performed as in FIG. 2. However, the present disclosure is not limited thereto.

Optionally, the procedure as shown in FIG. 5 may comprise step 504, where one or more procedures for BDT warning notification are complete. The procedure for BDT warning notification may be performed as in FIG. 4. However, the present disclosure is not limited thereto.

At step 506, the PCF 104 may determine that the network performance has recovered from a degraded network performance for the desired time window, based on the subscription of notification of network performance performed by the PCF 104 in procedure for BDT negotiation (as shown in FIG. 3) and/or the procedure for BDT warning notification (as shown in FIG. 4). In an embodiment, the PCF 104's subscription to NWDAF analytics may be performed on PCF NF (Network Function) instance level. In other words, the PCF 104 may subscribe NWDAF analytics for a same time window and/or location for multiple BDT policies for one or more AFs. For example, the PCF 104 may subscribe NWDAF analytics for a time window and/or location for a BDT policy with the earliest negotiation time, and for subsequent BDT policies for the same time window and/or location, the PCF 104 may not subscribe the NWDAF analytics repeatedly.

In an embodiment, the AF 108 may perform more than one negotiation for BDT. In this case the PCF 104 may, for each BDT policy negotiation that subscribed with NWDAF for notification of network performance recovery, determine the BDT policies related to the conditions required during initial negotiation for each affected ASP.

At steps 508 and 510, the PCF 104 may interact with the UDR 102 to retrieve all BDT policies stored in the UDR 102, and information about the current selection of BDT policy by the AF 108, for example, using an Nudr_DM_Query request message and an Nudr_DM_Query request message.

At step 512, the PCF 104 may determine one or more new candidate BDT policies. In an embodiment, if the information about the current selection of BDT policy by the AF 108 indicates a “NONE SELECTED” status, the PCF 104 may determine the one or more new candidate BDT policies based on the desired time window and/or location and/or network area, and the “NONE SELECTED” status. If the information indicates that the BDT policy currently selected by the AF 108 is a “degraded BDT policy”, the PCF 104 may determine the one or more new candidate BDT policies based on the desired time window and/or location and/or network area. In an embodiment, the PCF may include the BDT policy currently selected/used by the AF 108 within the determined one or more new candidate BDT policies, to allow the AF 108 to continue, if desired, with the previously selected BDT policy despite the network performance change.

At step 514, the PCF 104 may notify, to the NEF 106, the notification of network performance recovery and the determined one or more new BDT policies, for example, using an Npcf_BDTPolicyControl_notify message.

At step 516, the NEF 106 may notify, to the AF 108, the notification of network performance recovery and the determined one or more new BDT policies, for example, using an Nnef_BDTPNegotiation_notify message.

At step 518, the AF 108 may select a BDT policy from the one or more new BDT policies.

At step 520, the AF 108 may notify the PCF 104 about the selected BDT policy, via the NEF 106, for example using the steps 126-136 in FIG. 1. In an embodiment, if AF 108 selects a BDT policy with better (or same) condition (e.g. higher bandwidth and/or charging rate) than the previously selected BDT policy, the PCF 104 may subscribe, to the NWDAF, notification of network performance for time window of the newly selected BDT policy, and unsubscribe, to the NWDAF, the notification of network performance for the desired time window and time window of the previously selected “degraded BDT policy”, if any.

At steps 522 and 524, the PCF 104 may interact with the UDR 102, for example, using an Nudr_DM_Delete request message and an Nudr_DM_Delete response message, to store the selected BDT policy in the UDR 102. In an embodiment, if the AF 108 selects a BDT policy different from the previously selected “degraded BDT policy”, the PCF 104 may remove the previously selected “degraded BDT policy” from the UDR 102. In another embodiment, if the AF selects the previously selected “degraded BDT policy” at step 518 despite the network performance recovery, the PCF 104 may remove the “degraded BDT policy” flag, and store the selected BDT policy in the UDR 102. In this case, the PCF 104 may further keep the subscription of network performance for the time window of the selected BDT policy, and unsubscribe, to the NWDAF, notification of network performance for the desired time window, In an embodiment, the PCF 104 may further store the time window of the selected BDT policy as desired time window.

Finally and optionally, at step 526, a UE Policy Association Modification procedure as defined in 3GPP TS 23.502, clause 4.16.12.2 may be triggered in the PCF 104, where if there is a new BDT policy stored in the UDR 102, the PCF 104 may be notified by the UDR 102.

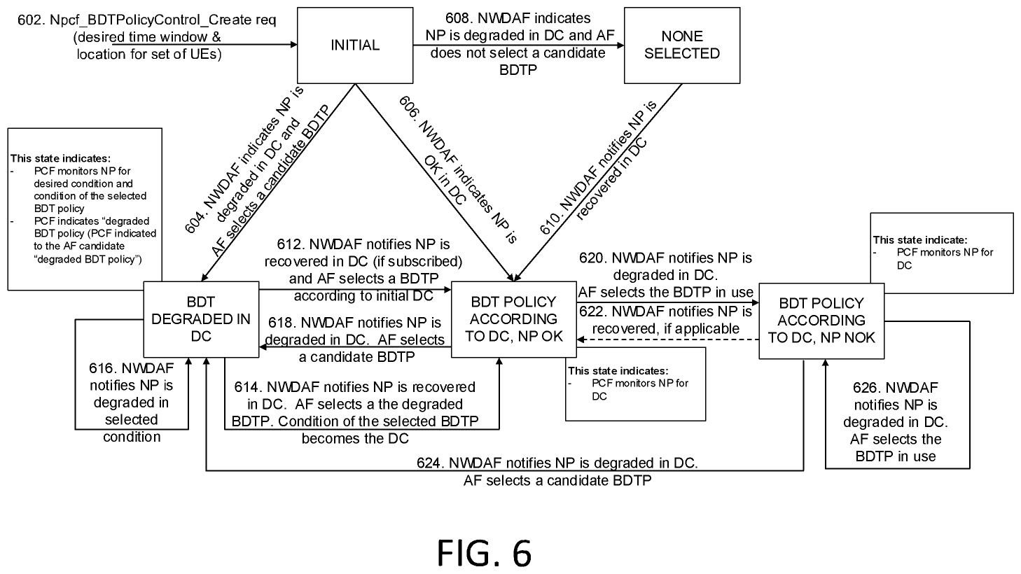

FIG. 6 is a diagram illustrating an exemplary state machine for BDT policy negotiation in PCF, according to an embodiment of the present disclosure.

In the exemplary state machines in FIG. 6, the following abbreviations are used:
DC: Desired Condition, a collection of desired time window and/or location
NP: Network Performance
NOK: Not OK
BDTP: BDT Policy

As shown in FIG. 6, five states for BDT policy negotiation may be defined in the PCF 104:
INITIAL
BDT DEGRADED IN DC
BDT POLICY ACCORDING TO DC, NP OK
BDT POLICY ACCORDING TO DC, NP NOK
NONE SELECTED

Firstly, as show in 602, when the PCF 104 receives for example an Nnef_BDTPolicyControl_Create request message for negotiating a BDT policy from the NEF 106 (as described in step 304 in FIG. 3), the state machine is initiated, and the state for BDT policy negotiation is initialized as “INITIAL”.

When the state machine is in state of “INITIAL”:
As shown in 604, if the NWDAF indicates that the network performance for the desired time window is degraded and the AF 108 selects a candidate BDT policy (for example, as described at steps 316 & 318 in FIG. 3), the state machine may be triggered to transfer to the state of “BDT DEGRADED IN DC”.
As shown in 606, if the NWDAF indicates that the network performance for the desired time window is good/OK and the AF 108 selects a candidate BDT policy (for example, as described at steps 316 & 318 in FIG. 3), the state machine may be triggered to transfer to the state of “BDT POLICY ACCORDING TO DC, NP OK”.
As shown in 608, if the NWDAF indicates that the network performance for the desired time window is degraded and the AF 108 does not select any candidate BDT policy (for example, as described at steps 316 & 318 in FIG. 3), or if the PCF 104 receives no message from the NEF 106 for indicating a BDT policy selected by the AF 108, the state machine may be triggered to transfer to the state of “NONE SELECTED”.

When the state machine is in state of “NONE SELECTED”:
As shown in 610, if the NWDAF notifies that the network performance for the desired time window is recovered (for example, as described at step 506 in FIG. 5), the state machine may be triggered to transfer to the state of “BDT POLICY ACCORDING TO DC, NP OK”.

When the state machine is in state of “BDT DEGRADED IN DC”:
As shown in 612, if the NWDAF notifies that the network performance for the desired time window is recovered (as described at step 506 in FIG. 5), and the AF 108 selects a BDT policy different from a previous “degraded BDT policy” (for example, as described at steps 518 & 520 in FIG. 5), the state machine may be triggered to transfer to the state of “BDT POLICY ACCORDING TO DC, NP OK”.
As shown in 614, if the NWDAF notifies that the network performance for the desired time window is recovered (for example, as described at step 506 in FIG. 5), and the AF 108 selects the previous “degraded BDT policy” (for example, as described at steps 518 & 520 in FIG. 5), the state machine may be triggered to transfer to the state of “BDT POLICY ACCORDING TO DC, NP OK”. In this case, the time window of the selected BDT policy becomes the desired time window, as described at step 520 in FIG. 5.
As shown in 616, if the NWDAF notifies that the network performance for the desired time window is degraded (for example, as described at step 404 in FIG. 4), the state machine remains in the state of “BDT DEGRADED IN DC”.

When the state machine is in state of “BDT POLICY ACCORDING TO DC, NP OK”:
As shown in 618, if the NWDAF notifies that the network performance for the desired time window is degraded (for example, as described at step 404 in FIG. 4), and the AF 108 selects a candidate BDT policy (as described at steps 416 & 418 in FIG. 4), the state machine may be triggered to transfer to the state of “BDT DEGRADED IN DC”.
As shown in 620, if the NWDAF notifies that the network performance for the desired time window is degraded (for example, as described at step 404 in FIG. 4), and the AF 108 selects the previously selected BDT policy (i.e., the currently used BDT policy) (for example, as described at steps 416 & 418 in FIG. 4), the state machine may be triggered to transfer to the state of “BDT POLICY ACCORDING TO DC, NP NOK”.

When the state machine is in state of “BDT POLICY ACCORDING TO DC, NP NOK”:
As shown in 622, if the NWDAF notifies that the network performance for the desired time window is recovered (for example, as described at step 506 in FIG. 5), the state machine may be triggered to transfer to the state of “BDT POLICY ACCORDING TO DC, NP OK”.
As shown in 624, if the NWDAF notifies that the network performance for the desired time window is degraded (for example, as described at step 404 in FIG. 4), and the AF 108 select a candidate BDT policy (for example, as described at steps 416 & 418 in FIG. 4), the state machine may be triggered to transfer to the state of “BDT DEGRADED IN DC”.
As shown in 626, if the NWDAF notifies that the network performance for the desired time window is degraded (for example, as described at step 404 in FIG. 4), and the AF 108 selects the previously selected BDT policy (i.e., the currently used BDT policy), the state machine may remain to the state of “BDT POLICY ACCORDING TO DC, NP NOK”.

In the states of “INITIAL”, “BDT POLICY ACCORDING TO DC, NP OK”, “BDT POLICY ACCORDING TO DC, NP NOK” and “NONE SELECTED”, the PCF 104 may monitor the network performance for the desired time and/or location by subscribing, to the NWDAF, information for indicating the network performance. In the state of “BDT DEGRADED IN DC”, the PCF 104 may monitor the network performance for the desired time and for the time window of the selected BDT policy.

It should be noted that, the names and/or numbers of the above states in FIG. 6 are provided only for facilitating the understanding of the present disclosure. There may be other names and/or numbers of states of BDT policy negotiation in the PCF 104.

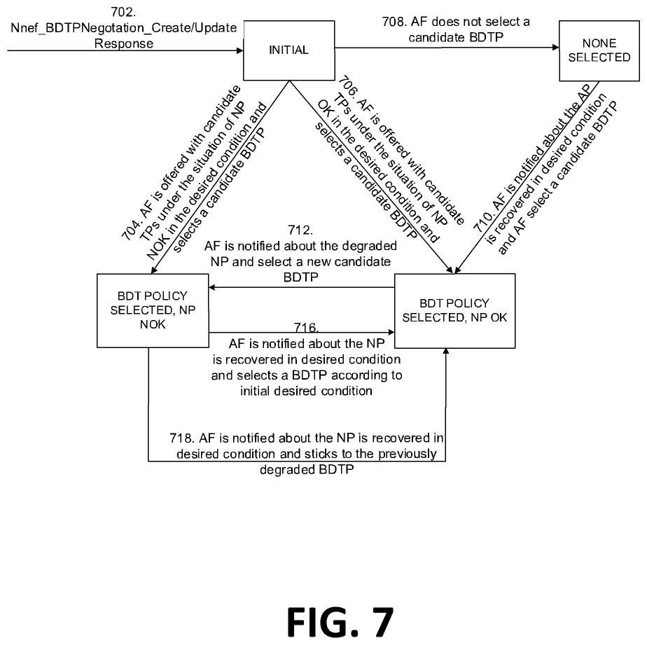

FIG. 7 illustrates a diagram illustrating an exemplary state machine for BDT policy negotiation in AF (e.g. AF 108), according to an embodiment of the present disclosure.

As shown in FIG. 7, four states for BDT policy negotiation may be defined in the AF 108:
INITIAL
BDT POLICY SELECTED, NP NOK
NONE SELECTED
BDT POLICY SELECTED, NP OK

Firstly, as show in 702, when the AF 108 receives for example an Nnef_BDTNegotiation_Create response or Nnef_BDTNegotiation_Update response message from the NEF 106 (for example, as described in step 314 or 322 in FIG. 3), the state machine may be initiated, and the state for BDT policy negotiation is initialized as “INITIAL”.

When the state machine is in state of “INITIAL”:
As shown in 704, if the AF 108 is offered with one or more candidate BDT policies under degraded network performance for the desired time window and it selects a candidate BDT policy (for example, as described at step 314 in FIG. 3), the state machine may be triggered to transfer to the state of “BDT POLICY SELECTED, NP NOK”.
As shown in 706, if the AF 108 is offered with one or more candidate BDT policies under good/optimal network performance for the desired time window and it selects a candidate BDT policy (for example, as described at step 314 in FIG. 3), the state machine may be triggered to transfer to the state of “BDT POLICY SELECTED, NP OK”.
As shown in 708, if the AF 108 is offered with one or more candidate BDT policies under degraded network performance for the desired time window and it does not select any candidate BDT policy, the state machine may be triggered to transfer to the state of “NONE SELECTED”.

When the state machine is in the state of “NONE SELECTED”:
As shown in 710, if the AF 108 is notified that the network performance is recovered for desired time window (for example, as described at 506 in FIG. 5) and it selects a candidate BDT policy (for example, as described at step 518 in FIG. 5), the state machine may be triggered to transfer to the state of “BDT POLICY SELECTED, NP OK”.

When the state machine is in the state of “BDT POLICY SELECTED, NP OK”:
As shown in 712, if the AF 108 is notified that the network performance is degraded for desired time window (for example, as described at 404 in FIG. 4) and it selects a new BDT policy that is different from the previously selected one (for example, as described at step 416 in FIG. 4), the state machine may be triggered to transfer to the state of “BDT POLICY SELECTED, NP NOK”.

When the state machine is in the state of “BDT POLICY SELECTED, NP NOK”:
As shown in 716, if the AF 108 is notified that the network performance is recovered for desired time window (for example, as described at 506 in FIG. 5) and it selects a BDT policy according to the initial desired time window (for example, as described at step 518 in FIG. 5), the state machine may be triggered to transfer to the state of “BDT POLICY SELECTED, NP OK”.
As shown in 718, if the AF 108 is notified that the network performance is recovered for desired time window (for example, as described at 506 in FIG. 5) and it selects the previously selected “degraded BDT policy” (for example, as described at step 518 in FIG. 5), the state machine may be triggered to transfer to the state of “BDT POLICY SELECTED, NP OK”.

It should be noted that, the names and/or numbers of the above states in FIG. 7 are provided only for facilitating the understanding of the present disclosure. There may be other names and/or numbers of states of BDT policy negotiation in the AF 108.

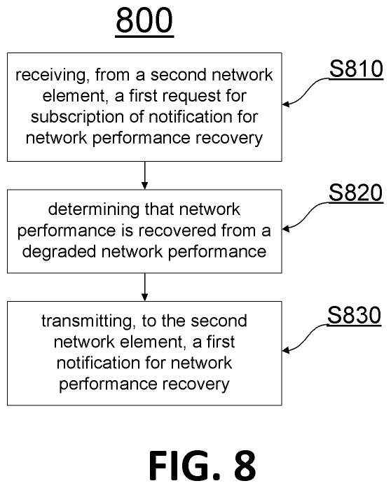

FIG. 8 is a flow chart of an exemplary method 800 at a first network element for managing BDT according to an embodiment of the present disclosure. The method 800 may be performed at a first network element (e.g., the PCF 104 shown in FIGS. 1-5) for managing BDT. The method 800 may comprise steps S810, S820 and S830. However, the present disclosure is not limited thereto. In some other embodiments, the method 800 may comprise more steps, less steps, different steps, or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step.

The method 800 may begin at step S810 where a first request for subscription of notification for network performance recovery may be received from a second network element. At step S820, it may be determined that network performance is recovered from a degraded network performance. At step S830, a first notification for network performance recovery may be transmitted to the second network element.

In some embodiments, before the step of determining that network performance is recovered from a degraded network performance, the method 800 may further comprise: transmitting, to a third network element, a second request for subscription of notification for network performance recovery; and receiving, from the third network element, a second notification for network performance recovery. In some embodiments, the step of determining that network performance is recovered from a degraded network performance may comprise: determining that the network performance is recovered from a degraded network performance at least partially based on the received second notification.

In some embodiments, each of the first and second requests for subscription of notification for network performance recovery may also request for subscription of notification for network performance degradation. In some embodiments, the method 800 may further comprise: determining that network performance is degraded; and transmitting, to the second network element, a third notification for network performance degradation.

In some embodiments, before the step of determining that network performance is degraded, the method 800 may further comprise: receiving, from the third network element, a fourth notification for network performance degradation. In some embodiments, the step of determining that network performance is degraded may comprise: determining that the network performance is degraded at least partially based on the received fourth notification.

In some embodiments, each of the first and second requests further may indicate a desired time window for BDT.

In some embodiments, after the step of receiving, from a second network element, a first request for subscription of notification for network performance recovery, the method 800 may further comprise: determining one or more first candidate BDT policies at least partially based on network performance for the desired time window; and transmitting, to the second network element, the determined one or more first candidate BDT policies.

In some embodiments, the method 800 may further comprise: receiving, from the second network element, a message indicating a BDT policy selected from the one or more first candidate BDT policies; and transmitting, to a fourth network element, a request for storing the selected BDT policy as a degraded and currently selected BDT policy or a desired and currently selected BDT policy depending on whether the network performance is degraded or not.

In some embodiments, the method 800 may further comprise: receiving, from the second network element, a message indicating that none of the one or more first candidate BDT policies is selected.

In some embodiments, upon the step of determining that the network performance is degraded, the method 800 may further comprise: determining one or more second candidate BDT policies at least partially based on degraded network performance. In some embodiments, the step of transmitting, to the second network element, a third notification for network performance degradation may comprise: transmitting, to the second network element, the determined one or more second candidate BDT policies together with the third notification.

In some embodiments, the method 800 may further comprise: receiving, from the second network element, a message indicating a BDT policy selected from the one or more second candidate BDT policies; and transmitting, to the fourth network element, a request for storing the selected BDT policy as a degraded and currently selected BDT policy.

In some embodiments, the method 800 may further comprises: determining whether a time window of the selected BDT policy is identical to that of any of currently subscribed notifications for network performance or not; and transmitting, to the third network element, a request for subscription of notification for network performance for the time window of the selected BDT policy, in response to determining that the time window of the selected BDT policy is not identical to that of any of currently subscribed notifications for network performance.

In some embodiments, the method 800 may further comprise: transmitting, to the third network element, a request for un-subscription of notification for network performance for a time window of a previously selected BDT policy, if any, when the previously selected BDT policy is a degraded BDT policy.

In some embodiments, the method 800 may further comprise: receiving, from the second network element, a message indicating that none of the one or more second candidate BDT policies is selected; and transmitting, to the fourth network element, a request for removing the previously selected BDT policy if any.

In some embodiments, the method 800 may further comprise: transmitting, to the fourth network element, a request for removing the previously selected BDT policy, if any, in response to receiving no response from the second network element within a period of time since the determined one or more second candidate BDT policies are transmitted to the second network element.

In some embodiments, upon the step of determining that the network performance is recovered, the method 800 may further comprise: determining one or more third candidate BDT policies at least partially based on recovered network performance. In some embodiments, the step of transmitting, to the second network element, a first notification for network performance recovery may comprise: transmitting, to the second network element, the determined one or more third candidate BDT policies and/or the degraded and currently selected BDT policy, if any, together with the first notification.

In some embodiments, the method 800 may further comprise: receiving, from the second network element, a message indicating a BDT policy newly selected from the one or more third candidate BDT policies and/or the degraded and currently selected BDT policy; and transmitting, to a fourth network element, a request for storing the newly selected BDT policy as the desired and currently selected BDT policy.

In some embodiments, the method 800 may further comprise: determining whether a time window of the newly selected BDT policy is identical to that of any of currently subscribed notifications for network performance or not; and transmitting, to the third network element, a request for subscription of notification for network performance for the time window of the newly selected BDT policy, in response to determining that the time window of the newly selected BDT policy is not identical to that of any of currently subscribed notifications for network performance.

In some embodiments, the method 800 may further comprise: transmitting, to the third network element, a request for un-subscription of notification for network performance for the previously desired time window when the previously desired time window is different from the time window of the newly selected BDT policy.

In some embodiments, the method 800 may further comprise: transmitting, to the third network element, a request for un-subscription of notification for network performance for the time window of the previously selected BDT policy, if any, when the time window of the previously selected BDT policy is different from the time window of the newly selected BDT policy.

In some embodiments, the first network element may be a PCF, the second network element may be an NEF, the third network element may be an NWDAF, and the fourth network element may be a UDR.

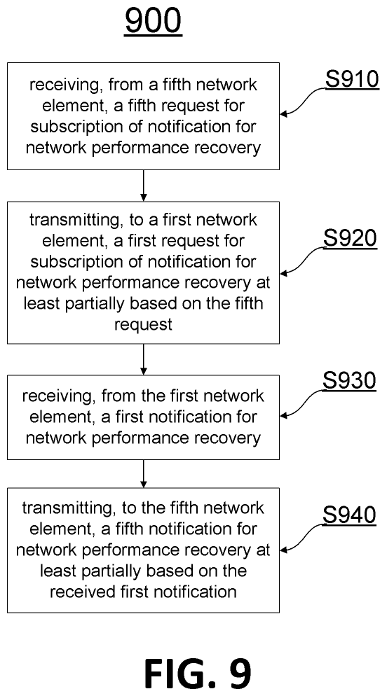

FIG. 9 is a flow chart of an exemplary method 900 at a second network element for managing BDT according to an embodiment of the present disclosure. The method 900 may be performed at a second network element (e.g., the NEF 106 shown in FIGS. 1-5) for managing BDT. The method 900 may comprise steps S910, S920, S930 and S940. However, the present disclosure is not limited thereto. In some other embodiments, the method 900 may comprise more steps, less steps, different steps, or any combination thereof. Further the steps of the method 900 may be performed in a different order than that described herein. Further, in some embodiments, a step in the method 900 may be split into multiple sub-steps and performed by different entities, and/or multiple steps in the method 900 may be combined into a single step.

The method 900 may begin at step S910 where a fifth request for subscription of notification for network performance recovery may be received from a fifth network element. At step S920, a first request for subscription of notification for network performance recovery may be transmitted to the first network element at least partially based on the fifth request. At step S930, a first notification for network performance recovery may be received from the first network element. At step S940, a fifth notification for network performance recovery may be transmitted to the fifth network element at least partially based on the received first notification.

In some embodiments, each of the first and fifth requests for subscription of notification for network performance recovery may also request for subscription of notification for network performance degradation. In some embodiments, the method 900 may further comprise: receiving, from the first network element, a third notification for network performance degradation; and transmitting, to the fifth network element, a sixth notification for network performance degradation at least partially based on the received third notification.

In some embodiments, each of the first and fifth requests further may indicate a desired time window for BDT.

In some embodiments, after the step of transmitting, to a first network element, a first request for subscription of notification for network performance recovery, the method 900 may further comprise: receiving, from the first network element, one or more first candidate BDT policies; and transmitting, to the fifth network element, the received one or more first candidate BDT policies.

In some embodiments, the method 900 may further comprise: receiving, from the fifth network element, a message indicating a BDT policy selected from the one or more first candidate BDT policies; and transmitting, to the first network element, a message indicating the selected BDT policy.

In some embodiments, the method 900 may further comprise: receiving, from the fifth network element, a message indicating none of the one or more first candidate BDT policies is selected; and transmitting, to the first network element, a message indicating that none of the one or more first candidate BDT policies is selected.

In some embodiments, the step of receiving, from the first network element, a third notification for network performance degradation may comprise: receiving, from the first network element, one or more second candidate BDT policies together with the third notification. In some embodiments, the step of transmitting, to the fifth network element, a sixth notification for network performance degradation may comprise: transmitting, to the fifth network element, the one or more second candidate BDT policies together with the sixth notification.

In some embodiments, the method 900 may further comprise: receiving, from the fifth network element, a message indicating a BDT policy selected from the one or more second candidate BDT policies; and transmitting, to the first network element, a message indicating the selected BDT policy.

In some embodiments, the method 900 may further comprise: receiving, from the fifth network element, a message indicating that none of the one or more second candidate BDT policies is selected; and transmitting, to the first network element, a message indicating that none of the one or more second candidate BDT policies is selected.

In some embodiments, the step of receiving, from the first network element, a first notification for network performance recovery may comprise: receiving, from the first network element, one or more third candidate BDT policies and/or a degraded and currently selected BDT policy, if any, together with the first notification. In some embodiments, the step of transmitting, to the fifth network element, a fifth notification for network performance recovery may comprise: transmitting, to the fifth network element, the one or more third candidate BDT policies and/or the degraded and currently selected BDT policy, if any, together with the fifth notification.

In some embodiments, the method 900 may further comprise: receiving, from the fifth network element, a message indicating a BDT policy newly selected from the one or more third candidate BDT policies and/or the degraded and currently selected BDT policy; and transmitting, to the first network element, a message indicating the newly selected BDT policy. In some embodiments, the first network element may be a PCF, the second network element may be an NEF, and the fifth network element may be an AF.

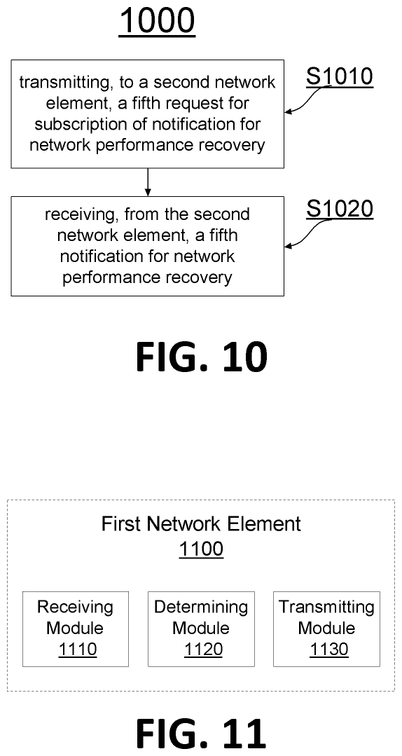

FIG. 10 is a flow chart of an exemplary method 1000 at a fifth network element for managing BDT according to an embodiment of the present disclosure. The method 1000 may be performed at a fifth network element (e.g., the AF 108 shown in FIGS. 1-5) for managing BDT. The method 1000 may comprise steps S1010 and S1020. However, the present disclosure is not limited thereto. In some other embodiments, the method 1000 may comprise more steps, less steps, different steps, or any combination thereof. Further the steps of the method 1000 may be performed in a different order than that described herein. Further, in some embodiments, a step in the method 1000 may be split into multiple sub-steps and performed by different entities, and/or multiple steps in the method 1000 may be combined into a single step.

The method 1000 may begin at step S1010 where a fifth request for subscription of notification for network performance recovery may be transmitted to a second network element. At step S1020, a fifth notification for network performance recovery may be received from the second network element.

In some embodiments, the fifth request for subscription of notification for network performance recovery may also request for subscription of notification for network performance degradation. In some embodiments, the method 1000 may further comprise: receiving, from the second network element, a sixth notification for network performance degradation. In some embodiments, the fifth request may further indicate a desired time window for BDT.

In some embodiments, after the step of transmitting, to a second network element, a fifth request for subscription of notification for network performance recovery, the method 1000 may further comprise: receiving, from the second network element, one or more first candidate BDT policies; selecting a BDT policy from the received one or more first candidate BDT policies; and transmitting, to the second network element, the selected BDT policy as the desired and currently selected BDT policy.

In some embodiments, after the step of transmitting, to a second network element, a fifth request for subscription of notification for network performance recovery, the method 1000 may further comprise: receiving, from the second network element, one or more first candidate BDT policies; selecting none of the one or more first candidate BDT policies; and transmitting, to the second network element, a message indicating none of the one or more first candidate BDT policies is selected.

In some embodiments, the step of receiving, from the second network element, a sixth notification for network performance degradation may comprise: receiving, from the second network element, one or more second candidate BDT policies together with the sixth notification.

In some embodiments, the method 1000 may further comprise: selecting a BDT policy from the one or more second candidate BDT policies; and transmitting, to the second network element, a message indicating the selected BDT policy as the degraded and currently selected BDT policy.

In some embodiments, the method 1000 may further comprise: selecting none of the one or more second candidate BDT policies; and transmitting, to the second network element, a message indicating that none of the one or more second candidate BDT policies is selected.

In some embodiments, the step of receiving, from the second network element, a fifth notification for network performance recovery may comprise: receiving, from the second network element, one or more third candidate BDT policies and/or the degraded and currently selected BDT policy, if any, together with the fifth notification.

In some embodiments, the method 1000 may further comprise: selecting a BDT policy from the one or more third candidate BDT policies and/or the currently selected BDT policy; and transmitting, to the second network element, a message indicating the newly selected BDT policy. In some embodiments, the second network element may be an NEF, and the fifth network element may be an AF.

Correspondingly to the method 800 as described above, an exemplary first network element is provided. FIG. 11 is a block diagram of a first network element 1100 according to an embodiment of the present disclosure. The first network element 1100 can be e.g., a PCF in a telecommunication network system. The first network element 1100 may function as a PCF.

The first network element 1100 can be configured to perform the method 800 as described above in connection with FIG. 8. As shown in FIG. 11, the first network element 1100 may comprise a receiving module 1110 configured to receive, from a second network element, a first request for subscription of notification for network performance recovery; a determining module 1120 configured to determine that network performance is recovered from a degraded network performance; and a transmitting module 1130 configured to transmit, to the second network element, a first notification for network performance recovery.

The above modules 1110, 1120 and/or 1130 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the first network element 1100 may comprise one or more further modules, each of which may perform any of the steps of the method 800 described with reference to FIG. 8.

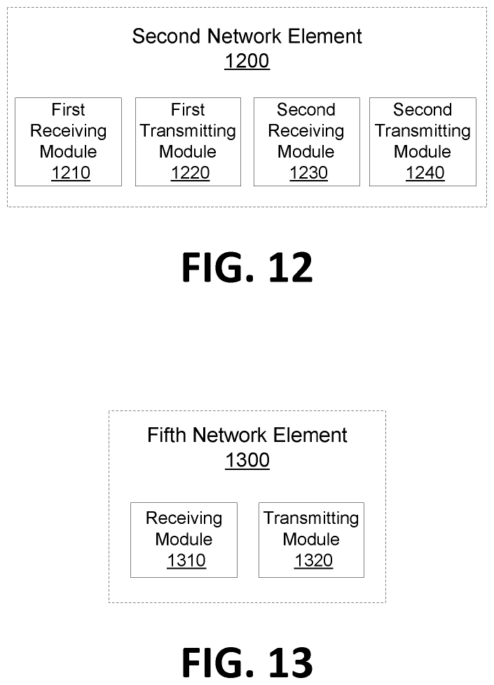

Correspondingly to the method 900 as described above, an exemplary second network element is provided. FIG. 12 is a block diagram of a second network element 1200 according to an embodiment of the present disclosure. The second network element 1200 can be e.g., an NEF in a telecommunication network system. The first network element 1200 may function as an NEF.

The second network element 1200 can be configured to perform the method 900 as described above in connection with FIG. 9. As shown in FIG. 12, the second network element 1200 may comprise a first receiving module 1210 configured to receive, from a fifth network element, a fifth request for subscription of notification for network performance recovery; a first transmitting module 1220 configured to transmit, to a first network element, a first request for subscription of notification for network performance recovery at least partially based on the fifth request; a second receiving module 1230 configure to receive, from the first network element, a first notification for network performance recovery; and a second transmitting module 1240 configured to transmit, to the fifth network element, a fifth notification for network performance recovery at least partially based on the received first notification.

The above modules 1210, 1220, 1230 and/or 1240 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 9. Further, the second network element 1200 may comprise one or more further modules, each of which may perform any of the steps of the method 900 described with reference to FIG. 9.

Correspondingly to the method 1000 as described above, an exemplary fifth network element is provided. FIG. 13 is a block diagram of a fifth network element 1300 according to an embodiment of the present disclosure. The fifth network element 1300 can be e.g., an AF in a telecommunication network system. The first network element 1300 may function as an AF.

The fifth network element 1300 can be configured to perform the method 1000 as described above in connection with FIG. 10. As shown in FIG. 13, the fifth network element 1300 may comprise a transmitting module 1310 configured to transmit, to a second network element, a fifth request for subscription of notification for network performance recovery; and a receiving module 1320 configure to receive, from the second network element, a fifth notification for network performance recovery.

The above modules 1310 and/or 1320 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 10. Further, the fifth network element 1300 may comprise one or more further modules, each of which may perform any of the steps of the method 1000 described with reference to FIG. 10.

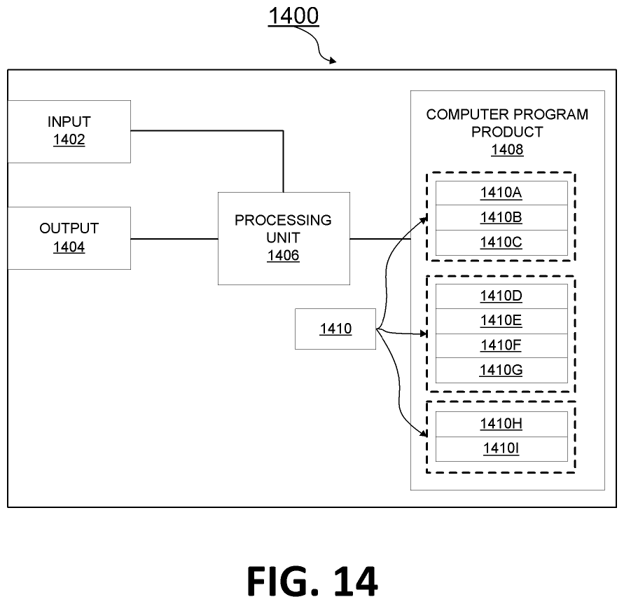

FIG. 14 schematically shows an embodiment of an arrangement which may be used in a first network element, a second network element and/or a fifth network element according to an embodiment of the present disclosure. Comprised in the arrangement 1100 are a processing unit 1406, e.g., with a Digital Signal Processor (DSP) or a Central Processing Unit (CPU). The processing unit 1406 may be a single unit or a plurality of units to perform different actions of procedures described herein. The arrangement 1400 may also comprise an input unit 1402 for receiving signals from other entities, and an output unit 1404 for providing signal(s) to other entities. The input unit 1402 and the output unit 1404 may be arranged as an integrated entity or as separate entities.

Furthermore, the arrangement 1400 may comprise at least one computer program product 1408 in the form of a non-volatile or volatile memory, e.g., an Electrically Erasable Programmable Read-Only Memory (EEPROM), a flash memory and/or a hard drive. The computer program product 1408 comprises a computer program 1410, which comprises code/computer readable instructions, which when executed by the processing unit 1406 in the arrangement 1400 causes the arrangement 1400 and/or the first network element, the second network element and/or the fifth network element in which it is comprised to perform the actions, e.g., of the procedure described earlier in conjunction with FIG. 1, FIG. 2, FIG. 3, FIG. 4, FIG. 5, FIG. 8, FIG. 9 and FIG. 10 or any other variant.

The computer program 1410 may be configured as a computer program code structured in computer program modules 1410A-1410C. Hence, in an exemplifying embodiment when the arrangement 1400 is used in the first network element, the code in the computer program of the arrangement 1400 includes: a reception module 1410A for receiving, from a second network element, a first request for subscription of notification for network performance recovery, a determining module 1410B for determining that network performance is recovered from a degraded network performance, and a transmitting module 1410C for transmitting, to the second network element, a first notification for network performance recovery.

The computer program 1410 may be further configured as a computer program code structured in computer program modules 1410D-1410G. Hence, in an exemplifying embodiment when the arrangement 1400 is used in the second network element, the code in the computer program of the arrangement 1400 includes: a reception module 1410D for receiving, from a fifth network element, a fifth request for subscription of notification for network performance recovery, a transmission module 1410E for transmitting, to a first network element, a first request for subscription of notification for network performance recovery at least partially based on the fifth request, a reception module 1410F for receiving, from the first network element, a first notification for network performance recovery; and a transmission module 1410G for transmitting, to the fifth network element, a fifth notification for network performance recovery at least partially based on the received first notification.

The computer program 1410 may be further configured as a computer program code structured in computer program modules 1410H-1410I. Hence, in an exemplifying embodiment when the arrangement 1400 is used in the fifth network element, the code in the computer program of the arrangement 1400 includes: a transmission module 1410H for transmitting, to a second network element, a fifth request for subscription of notification for network performance recovery, and a reception module 1410I for receiving, from the second network element, a fifth notification for network performance recovery.

The computer program modules could essentially perform the actions of the flow illustrated in FIG. 1, FIG. 2, FIG. 3, FIG. 4, FIG. 5, FIG. 8, FIG. 9, and FIG. 10, to emulate the first network element, the second network element, or the fifth network element. In other words, when the different computer program modules are executed in the processing unit 1406, they may correspond to different modules in the first network element or the second network element.

With the first network element, the second network element, the fifth network element, and methods performed at the network elements as described above, it enables AF to be aware of network performance changes that occur in requested and selected locations and time intervals, and adapt accordingly corresponding application traffic, if necessary.

Although the code means in the embodiments disclosed above in conjunction with FIG. 14 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1-48. (canceled)

49. A method at a first network element for managing background data transfer (BDT), the method comprising:
receiving, from a second network element, a first request for a subscription of notification for network performance recovery;
determining that a network performance is recovered from a degraded network performance; and
transmitting, to the second network element, a first notification for the network performance recovery.

50. The method of claim 49, wherein the method further comprises:
transmitting, to a third network element, a second request for the subscription of notification for network performance recovery before determining that network performance is recovered from a degraded network performance; and
receiving, from the third network element, a second notification for network performance recovery; and
wherein determining that network performance is recovered from a degraded network performance comprises determining that the network performance is recovered from a degraded network performance at least partially based on the received second notification.

51. The method of claim 50, further comprising:
determining that network performance is degraded;
transmitting, to the second network element, a third notification for network performance degradation; and
wherein each of the first and second requests for subscription of notification for network performance recovery also requests for subscription of notification for network performance degradation.

52. The method of claim 51, further comprising:
receiving, from the third network element, a fourth notification for network performance degradation before determining that network performance is degraded; and
wherein determining that network performance is degraded comprises determining that the network performance is degraded at least partially based on the received fourth notification.

53. The method of claim 50, wherein each of the first and second requests further indicates a desired time window for BDT.

54. The method of claim 53, further comprises:
determining one or more first candidate BDT policies at least partially based on network performance for the desired time window after receiving, from a second network element, a first request for subscription of notification for network performance recovery; and
transmitting, to the second network element, the determined one or more first candidate BDT policies.

55. The method of claim 54, further comprises:
receiving, from the second network element, a message indicating a BDT policy selected from the one or more first candidate BDT policies; and
transmitting, to a fourth network element, a request for storing the selected BDT policy as a degraded and currently selected BDT policy or a desired and currently selected BDT policy depending on whether the network performance is degraded or not.

56. The method of claim 54, further comprises receiving, from the second network element, a message indicating that none of the one or more first candidate BDT policies is selected.

57. The method of claim 56, further comprises:
determining one or more second candidate BDT policies at least partially based on degraded network performance upon determining that the network performance is degraded; and
transmitting, to the second network element, the determined one or more second candidate BDT policies together with the third notification.

58. The method of claim 57, further comprises:
receiving, from the second network element, a message indicating a BDT policy selected from the one or more second candidate BDT policies; and
transmitting, to a fourth network element, a request for storing the selected BDT policy as a degraded and currently selected BDT policy.

59. A first network element for managing background data transfer (BDT), the first network element comprising:
processing circuitry and memory, the memory containing instructions executable by the processing circuitry, whereby the first network element is configured to:
receive, from a second network element, a first request for a subscription of notification for network performance recovery;
determine that a network performance is recovered from a degraded network performance; and
transmit, to the second network element, a first notification for the network performance recovery.

60. The first network element of claim 59, further configured to:
transmit, to a third network element, a second request for the subscription of notification for network performance recovery before determining that network performance is recovered from a degraded network performance; and
receive, from the third network element, a second notification for network performance recovery; and
wherein the first network element is configured to determine that the network performance is recovered from a degraded network performance at least partially based on the received second notification.

61. The first network element of claim 60, further configured to:
determine that network performance is degraded; and
transmit, to the second network element, a third notification for network performance degradation.

62. The first network element of claim 61, further configured to:
receive, from the third network element, a fourth notification for network performance degradation before determining that network performance is degraded; and
wherein the first network element is configured to determine that the network performance is degraded at least partially based on the received fourth notification.

63. The first network element of claim 60, wherein each of the first and second requests further indicates a desired time window for BDT.

64. The first network element of claim 63, further configured to:
determine one or more first candidate BDT policies at least partially based on network performance for the desired time window after receiving, from a second network element, a first request for subscription of notification for network performance recovery; and
transmit, to the second network element, the determined one or more first candidate BDT policies.

65. The first network element of claim 64, further configured to:
receive, from the second network element, a message indicating a BDT policy selected from the one or more first candidate BDT policies; and
transmit, to a fourth network element, a request for storing the selected BDT policy as a degraded and currently selected BDT policy or a desired and currently selected BDT policy depending on whether the network performance is degraded or not.

66. The first network element of claim 64, further configured to receive, from the second network element, a message indicating that none of the one or more first candidate BDT policies is selected.

67. The first network element of claim 66, further configured to:
determine one or more second candidate BDT policies at least partially based on degraded network performance upon determining that the network performance is degraded; and
transmit, to the second network element, the determined one or more second candidate BDT policies together with the third notification.

68. A non-transitory computer-readable medium storing a computer program product for controlling a first network element, the computer program product comprising software instructions that, when run on the first network element, causes the first network element to:
receive, from a second network element, a first request for a subscription of notification for network performance recovery;
determine that a network performance is recovered from a degraded network performance; and
transmit, to the second network element, a first notification for the network performance recovery.
